(19) United States
(12) Patent Application Publication
(10) Pub. No.: US 2003/0117616 A1
(43) Pub. Date: Jun. 26, 2003

(54) Wafer external inspection apparatus

(75) Inventor: Toyokazu Nakamura, Kanagawa (JP)

Correspondence Address: YOUNG & THOMPSON, 745 SOUTH 23RD STREET 2ND FLOOR, ARLINGTON, VA, 22202

(73) Assignee: NEC ELECTRONICS CORPORATION, Kanagawa (JP)

(21) Appl. No.: 10/321,663

(22) Filed: Dec. 18, 2002

(30) Foreign Application Priority Data
Dec. 21, 2001 (JP) 2001-389626

(51) Int. Cl. G01N 21/00

(52) U.S. Cl. 356/237.5

(57) ABSTRACT

There is disclosed a wafer external inspection apparatus of a dark field reflective type for irradiating an external defect on a surface of a die on a semiconductor device wafer with incoherent illumination to detect the external defect from an image captured by a one-dimensional camera, the apparatus comprising illumination means in which an azimuth angle of at least one incoherent illumination becomes a 45-degree group azimuth of about 45 degrees, about 135 degrees, about 225 degrees or about 315 degrees within the surface of the wafer with respect to an azimuth of patterns occupying a majority in the die.

### BACKGROUND OF THE INVENTION

1. Field of the Invention

The present invention relates to a wafer external inspection apparatus, and more particularly, it relates to a wafer external inspection apparatus using incoherent dark field illumination.

2. Description of the Related Art

A wafer external inspection apparatus of a dark field reflective type using incoherent illumination is generally used as an external inspection apparatus for detecting external defects of a die on a semiconductor device wafer.

This conventional apparatus for inspecting a wafer surface for defects using dark field illumination includes one disclosed in Japanese Patent Publication Laid-open No. 11-051622 (conventional example 1). In the inspection apparatus in this case, as shown in a block diagram including a partial perspective view of a foreign object inspection apparatus of FIG. 3, a white light illumination device 40 and an image capturing device 45 are provided for a foreign object inspection apparatus 10 in which a light source device 12a for irradiating inspection light illuminates a wafer 1 obliquely, and a scattered light detector 34 detects the scattered light caused by the inspection light on the wafer 1 in the dark field, thereby specifying coordinate positions of a foreign object 5. The coordinate positions of the foreign object 5, which are specified by a foreign object judgment device 35 on the basis of the detection according to the scattered light detector 34 are captured by the image capturing device 45 comprising line sensors, under bright field illumination by the white light illumination device 40, and an image of the foreign object is extracted on the basis of the image capturing, thereby specifying the size, shape, color and properties of the foreign object according to the extracted image of the foreign object.

This foreign object inspection apparatus 10 detects the scattered light from a wafer, which is a test subject, caused by the oblique illumination in the dark field, and recognizes the presence, position coordinates and number of foreign objects according to the coordinates at the detection of the scattered light. The inspection light irradiation device 12a is set obliquely above a stage 6 on which the wafer 1 is mounted, and this inspection light irradiation device 12a comprises a laser light source 12b for irradiating the wafer 1 with laser light as the inspection light, and a condenser 11 for condensing the laser light, so that the wafer 1 is obliquely illuminated by irradiating the wafer 1 as a test subject held on the stage 6 with the condensed laser light at a low angle.

Furthermore, a scattered light detection device 30 is set directly above the stage 6, and this scattered light detection device 30 comprises an objective lens 14a for condensing the scattered light diffusely reflected on the surface of the wafer 1 as the surface of the wafer 1 is obliquely irradiated with the laser light, and a relay lens 33 for imaging the scattered light condensed by the objective lens 14a on a light-receiving surface of the scattered light detector 34. In other words, the scattered light detection device 30 detects the scattered light in the dark field. In addition, the scattered light detector 34 comprises line sensors in which solid-state image capturing photoelectric transfer devices are arranged long and narrowly, and is disposed to be long in a Y direction perpendicular to the moving direction of the stage.

The foreign object judgment device 35 is connected to the scattered light detector 34, and this foreign object judgment device 35 is constituted to judge the presence of a foreign object on the wafer 1 on the basis of a detection point of the scattered light from the scattered light detector 34, and specifies the coordinate positions of the foreign object by collating coordinate position data of the stage 6 with data of the judgment. The scattered light detector 34 sends the intensity of the scattered light to the foreign object judgment device 35.

When the wafer 1 is irradiated with laser light being the inspection light at an angle of low gradient by the inspection light irradiation device 12a, the foreign object 5 adhering on the surface of the wafer 1 and circuit patterns cause scattered light in the dark field, due to the laser light irradiation. This scattered light is condensed by an objective lens 32 and imaged on the scattered light detector 34 through the relay lens 33.

At this point, since the scattered light from the circuit patterns has regularity, the scattered light from the circuit patterns is shielded by a spatial filter provided on a Fourier transformation surface of a pattern surface on the wafer 1 or by a light-shielding element comprising analyzers. On the other hand, the scattered light from the foreign object 5 has irregularity, and thus passes through the spatial filter or the analyzers to be imaged on the scattered light detector 34. Therefore, only the foreign object 5 is detected.

A detection signal according to the scattered light from the foreign object 5 in the dark field detected by the scattered light detector 34 is input to the foreign object judgment device 35. The foreign object judgment device 35 judges the presence of the foreign object 5 on the basis of the detection signal, and specifies the coordinate positions of the foreign object 5 by collating the coordinate position data of the stage 6 with the judgment data. The coordinate positions of the foreign object 5 thus specified are output from the foreign object judgment device 35 to, for example, a host computer 18a for generally operating the foreign object inspection apparatus 10, and transmitted to a comparison unit 47 and a verification unit 48 that electrically continue to the image capturing device 45.

This apparatus for inspecting the wafer-surface for defects illuminates at about zero degrees or in one direction among an azimuth of about 90 degrees, about 180 degrees and about 270 degrees within the wafer surface, to the azimuth of the patterns that have a majority in a die.

In addition, in Japanese Patent Publication Laid-open No. 60-253822 (conventional example 2), dark field illumination is used which is in an azimuth other than a azimuth of about 45 degrees, about 135 degrees, about 225 degrees and about 315 degrees to the azimuth of the patterns that have a majority in a die.

Furthermore, in Japanese Patent Publication Laid-open No. 5-118994 (conventional example 3), in order to illuminate a surface having repeated patterns, parallel irradiation is applied at an angel of 45 degrees within the surface with regard to repeated rectangular lines.

According to the conventional dark field illumination methods described above, because reflected light from pattern corners in a die that does not have the repeated patterns is mixed in desired signal light, a camera is likely to reach a light reception saturation point during an optical low-powered inspection aiming for a high-speed inspection, thus having a problem that it is difficult to detect defects.

In addition, it is understood that optical scattering is not isotropic in linear defects such as a scratch in a die that does not have the repeated patterns, as Kataoka et al. introduce in the magazine of Japan Society for Precision Engineering Vol. 66, No. 11, 2000; pp. 1716 “light scattering due to corpuscles and minute defects on the surface of a silicon wafer”. Therefore, such a problem has been posed that defects are not necessarily detected with parallel illumination in at least one direction.

Furthermore, according to a conventional imaging optical system using a laser, due to the coherency of the laser, the pattern corners cause a so-called ringing noise and a so-called speckle noise tends to be caused in the whole area, which poses a problem that false errors are easily caused.

### SUMMARY OF THE INVENTION

The present invention is directed to a wafer external inspection apparatus of a dark field reflective type for irradiating an external defect on a surface of a die on a semiconductor device wafer with incoherent illumination to detect the external defect from an image captured by a one-dimensional camera, the apparatus comprising illumination means in which an azimuth angle of at least one incoherent illumination becomes a 45-degree group azimuth of about 45 degrees, about 135 degrees, about 225 degrees or about 315 degrees within the surface of the wafer with respect to an azimuth of patterns occupying a majority in the die.

### BRIEF DESCRIPTION OF THE DRAWINGS

The above-mentioned and other objects, features and advantages of this invention will become more apparent by reference to the following detailed description of the invention taken in conjunction with the accompanying drawings, wherein:

FIG. 1 is a constitution view of a wafer inspection system in accordance with a first embodiment of the present invention;

FIG. 2 is a plane view of an irradiation system and an optical mask in accordance with a second embodiment of the present invention; and

FIG. 3 is a perspective view of a wafer inspection system in a conventional example.

### DETAILED DESCRIPTION OF THE PREFERRED EMBODIMENTS

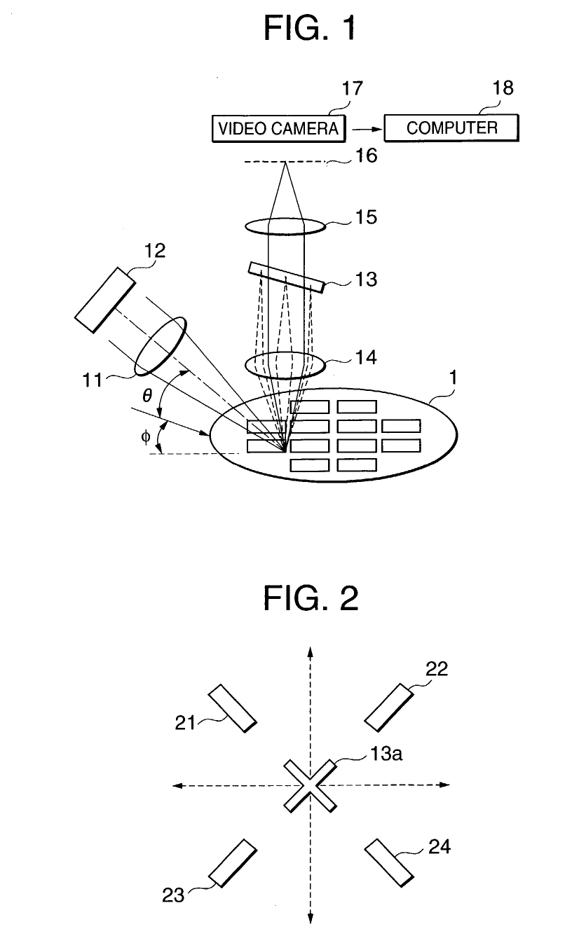

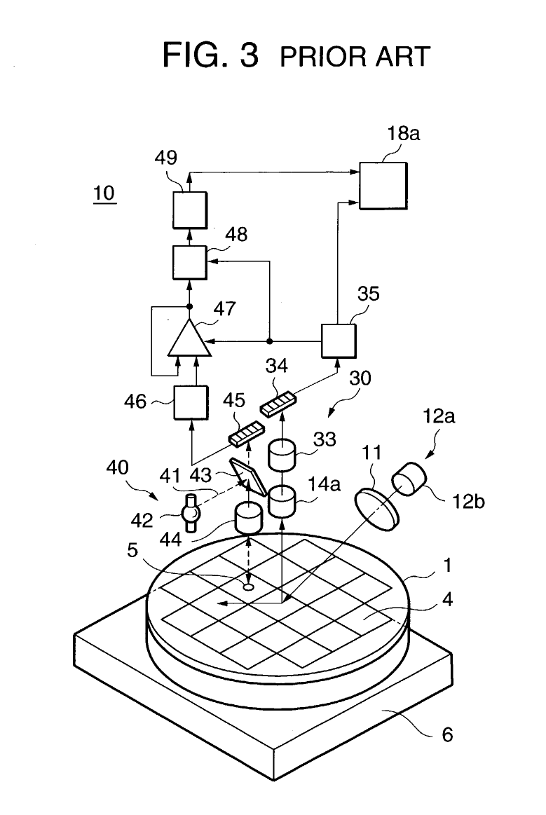

Next, embodiments of the present invention will be described in detail with reference to the drawings. FIG. 1 shows a constitution view of a first embodiment of the present invention. In FIG. 1, scattered light from a wafer 1 is indicated by broken lines, while scattered light from a defect having an uneven irregular shape on the wafer 1 is indicated by thin lines.

The surface of the wafer 1 is irradiated with a ray of light condensed through a convergent lens 11, with an incoherent light source 12, for example, a halogen lamp as a light source. The optical axis of this light is at about 45 degrees (ø) on the surface of the wafer with regard to the azimuth of a pattern edge predominant among patterns of the wafer. An elevation angle (θ) of the irradiated light selects an angle that prevents the scattered light from line parts of the pattern edge from scattering in the range where an objective lens 14 to which a Fourier transformation function is added views the wafer, and the angle needs to be smaller than about 85 degrees.

When the scattered light is acquired by use of the objective lens 14 under such illumination conditions, the scattering from the line parts of the pattern is hardly acquired, however, a great amount of scattered light is acquired, in corner parts where the pattern is bent or when the edge of the pattern is in a direction perpendicular to the optical axis of the irradiated light.

The primary part of the scattered light from the corner parts or the like passes through the objective lens 14, and then is condensed on a so-called Fourier transformation surface. The trace of the condensation is along the direction in which the optical axis of the irradiated light is projected on the wafer. Therefore, when on the Fourier transformation surface, a rectangular optical mask 13 is placed in the same direction as an azimuth in which its long axis is projected on the surface of the wafer 1, it is possible to block the scattered light from the aforementioned corner parts or the like.

On the other hand, the primary scattered light from the irregularly-shaped uneven defect on the surface of the wafer is not blocked by the optical mask 13, and is effectively imaged on an imaging surface 16 by an imaging lens 15. The imaged primary scattered light is captured by a video camera 17, and taken in by a computer 18, thereby detecting the defect from the captured image.

FIG. 2 is a plane view of a second embodiment of the present invention. This drawing shows incoherent light sources 21 to 24 in the case of using four light sources, and a cross-shaped optical mask 13a equivalent to the optical mask 13 of FIG. 1. In this case, since a plurality of light sources is used, it is possible to more precisely inspect for defects such as a scratch having anisotropy in the scattered light. Since the cross-shaped optical mask 13a is used in this case, the four light sources 21 to 24 in four directions are shown, however, it is possible to have different fields of vision with two light sources in different directions, which is obviously effective.

In this embodiment, the four fixed light sources 21 to 24 are shown, but it is apparent that one light source 21 may be equipped with a rotatable arm in order to become a 45-degree group azimuth of about 45 degrees, about 135 degrees, about 225 degrees or about 315 degrees.

In the embodiments above, convergent light is used as the irradiated light, however, the same effects can also be obtained with parallel light. In the case of the parallel light, when the area of a beam section of the parallel light is reduced as compared with the cross section area of the objective lens, it is possible to have the same light-shielding effects if the optical mask 13 is placed between the objective lens 14 and the wafer 1.

As described above, the constitution of the present invention offers an advantage that, by effectively shielding background scattering from the corner of unrepeated patterns and so-called oblique wiring patterns, it is possible to precisely and effectively inspect for uneven defects on a wafer having the unrepeated patterns.

Although the invention has been described with reference to specific embodiments, this description is not meant to be construed in a limiting sense. Various modifications of the disclosed embodiments will become apparent to persons skilled in the art upon reference to the description of the invention. It is therefore contemplated that the appended claims will cover any modifications or embodiments as fall within the true scope of the invention.

What is claimed is:

1. A wafer external inspection apparatus of a dark field reflective type for irradiating an external defect on a surface of a die on a semiconductor device wafer with incoherent illumination to detect the external defect from an image captured by a one-dimensional camera, the apparatus comprising illumination means in which an azimuth angle of at least one incoherent illumination becomes a 45-degree group azimuth of about 45 degrees, about 135 degrees, about 225 degrees or about 315 degrees within the surface of the wafer with respect to an azimuth of patterns occupying a majority in the die.

2. The wafer external inspection apparatus according to claim 1, wherein said illumination means is disposed so as to be fixed or rotated in a 45-degree group azimuth of about 45 degrees, about 135 degrees, about 225 degrees or about 315 degrees.

3. The wafer external inspection apparatus according to claim 1, wherein said illumination means are capable of illuminating at the same time in at least two azimuths that do not become a deviation of 180 degrees among the 45-degree group azimuths of about 45 degrees, about 135 degrees, about 225 degrees and about 315 degrees.

4. The wafer external inspection apparatus according to claim 1, wherein each incoherent illumination is constituted to place, in an imaging optical system, a rectangular optical mask, which has an azimuth being in the same direction as the azimuth of its illumination axis azimuth projected on the surface of the wafer, in the same direction as an azimuth in which its long axis is projected on the surface of the wafer.

5. The wafer external inspection apparatus according to claim 4, wherein the elevation angle of each incoherent illumination belongs to a range of about zero degrees to about 85 degrees.

6. The wafer external inspection apparatus according to claim 1, wherein in inspecting for defects by use of said one-dimensional camera, the primary scanning direction of said one-dimensional camera is the azimuth of the patterns that have a majority in a die.
